(19) United States
(12) Patent Application Publication
(10) Pub. No.: US 2026/0303213 A1
(43) Pub. Date: Oct. 1, 2026

(54) SYSTEM AND METHOD FOR LOW NOISE DISTRIBUTION OF TERAHERTZ WAVES USING OPTICAL FIBER AND NOISE CANCELLATION

(71) Applicant: IMRA America, Inc., Ann Arbor, MI (US)

(72) Inventors: Antoine Jean Gilbert Rolland, Longmont, CO (US); Brendan Michael Heffernan, Boulder, CO (US)

(21) Appl. No.: 19/093,016

(22) Filed: Mar. 27, 2025

(51) Int. Cl. H04B 10/2507; H04B 10/2575

(52) U.S. Cl. CPC H04B 10/2507; H04B 10/2575

(57) ABSTRACT

An apparatus, system, and method for phase and frequency noise cancellation in signals transmitted over at least one optical fiber link between a first station and at least one second station are provided. The method includes generating optical signals comprising two separate optical frequencies having a frequency difference in a range of 10 GHz to 10 THz, transmitting the optical signals along an optical path through the at least one optical fiber link, detecting phase and frequency fluctuations at the at least one second station, and applying error correction signals to the optical signals at one or more locations along the optical path. The error correction signals comprise frequency shifts derived from the detected phase and frequency fluctuations to mitigate noise in real-time.

### BACKGROUND

### Field

The present application relates to the distribution and dissemination of microwave, millimeter-wave, sub-terahertz, or terahertz signals over long distances using optical fiber.

### Description of the Related Art

Radio over fiber (RoF) is a well-established technology whereby radio signals are encoded on optical light via modulation and the optical light is distributed through optical fiber networks.

RoF was developed, in part, to address issues associated with wired distribution of radio signals using metal cables. These issues include attenuation and sensitivity to interference from other electromagnetic sources. Attenuation of light in optical fibers is comparatively small, allowing signals to travel larger distances while reducing the number of amplifiers necessary. Likewise, light in optical fibers is generally very insensitive to external electromagnetic fields (e.g., in the absence of specialized configurations), so signals can travel further with less accrued noise.

General trends in technology suggest that in the future, larger carrier frequencies will become increasingly common to allow for higher modulation bandwidths and therefore larger data transfer rates. For example, fifth-generation mobile network (5G) protocols allow for carrier frequencies up to 71 GHz, and many proposals for the sixth-generation mobile network (6G or beyond 5G) encompass frequencies up to at least 300 GHz. While mobile networks emphasize wireless transmission for the end user, the networks themselves still rely heavily on wired transmission for backhaul applications which often utilize RoF techniques and may continue to do so.

As carrier frequencies increase from the RF domain to the microwave and millimeter wave (mmW, also known as sub-terahertz) domains, issues with distribution over metal cables are exacerbated, particularly in terms of attenuation and loss. For instance, hollow metal waveguides currently exhibit the lowest loss for 300 GHz transmission, but this loss is still around 0.2 dB/cm, and the waveguides can also be bulky and prohibitively expensive.

Another significant potential application of the optical distribution of terahertz waves lies in time and frequency transfer. While this technology remains relevant for mobile networks, in this context, it can be focused on achieving precise clock synchronization and maintaining exceptional time stability of the distributed wave. By leveraging the inherent advantages of optical systems such as low propagation delays, minimal dispersion, and high immunity to electromagnetic interference, terahertz-based time and frequency transfer can offer unprecedented accuracy for critical applications (e.g., next generation communication networks, satellite based timing systems, ultra precise scientific experiments, and metrology infrastructures where nanosecond or picosecond level synchronization is utilized).

### SUMMARY

In certain implementations, an apparatus comprises a signal preparation module, a frequency control module, and a detection module. The signal preparation module is configured to receive a first optical signal comprising two first optical frequencies having a first frequency difference in a range of 10 GHz to 10 THz and to parse the first optical signal into a first portion of the first optical signal and a second portion of the first optical signal. The frequency control module is configured to receive the first portion of the first optical signal from the signal preparation module, to adjust the first portion of the first optical signal in response to at least one control signal by modifying at least one of the two first optical frequencies, to transmit the adjusted first portion of the first optical signal to at least one optical fiber link in optical communication with a device, and to receive the second optical signal from the at least one optical fiber link. The device is configured to receive at least a portion of the adjusted first portion of the first optical signal from the at least one optical fiber link, to, in response to the received adjusted first portion, generate a second optical signal comprising two second optical frequencies having a second frequency difference, the two second optical frequencies shifted equally relative to the two first optical frequencies of the received adjusted first portion, and to transmit the second optical signal back through the at least one optical fiber link. The detection module is configured to receive the second portion of the first optical signal and the second optical signal, to detect a frequency shift between the second portion of the first optical signal and the second optical signal, to generate the at least one control signal in response to the frequency shift, and to transmit the at least one control signal to the frequency control module.

In certain implementations, a system comprises a local station, at least one repeater station, and at least one optical fiber configured to transmit the optical signals from the local station to at least one remote station. The local station comprises a source of optical signals, each optical signal comprising two optical frequencies having a first frequency difference in a range of 10 GHz to 10 THz. The local station and/or at least one of the at least one repeater station comprises a first optical circuit, a second optical circuit, and a third optical circuit. The first optical circuit is configured to transmit a first power fraction of the optical signals along a first optical path and to transmit a second power fraction of the optical signals along a second optical path different from the first optical path. The second optical circuit is configured to generate a modified first power fraction by modifying the two optical frequencies of the first power fraction in response to control signals. The third optical circuit is configured to detect shifts of the two optical frequencies that are induced by propagation of the optical signals through the at least one optical fiber and to generate the control signals in response to the detected shifts.

In certain implementations, a method is provided for phase and frequency noise cancellation in microwave, millimeter-wave, sub-terahertz, or terahertz signals transmitted over at least one optical fiber link between a first station and at least one second station. The method comprises generating optical signals comprising two separate optical frequencies having a frequency difference in a range of 10 GHz to 10 THz. The method further comprises transmitting the optical signals along an optical path through the at least one optical fiber link. The method further comprises detecting phase and frequency fluctuations at the at least one second station. The method further comprises applying error correction signals to the optical signals at one or more locations along the optical path. The error correction signals comprise frequency shifts derived from the detected phase and frequency fluctuations to mitigate noise in real-time.

### BRIEF DESCRIPTION OF THE DRAWINGS

FIGS. 1A-1C schematically illustrate various example systems in accordance with certain implementations described herein.

FIG. 2 schematically illustrates an example first station in accordance with certain implementations described herein.

FIGS. 3A and 3B schematically illustrate two example signal preparation modules in accordance with certain implementations described herein.

FIGS. 4A-4D schematically illustrate various example frequency control modules in accordance with certain implementations described herein.

FIGS. 5A-5D schematically illustrate various example return modules in accordance with certain implementations described herein.

FIGS. 6A-6C schematically illustrate various example detection modules in accordance with certain implementations described herein.

FIGS. 7A-7C schematically illustrate various example third stations of the at least one third station in accordance with certain implementations described herein.

FIGS. 8A-8D schematically illustrate various example boost/return modules in accordance with certain implementations described herein.

FIG. 9 schematically illustrates an example system in accordance with certain implementations described herein.

FIG. 10 is a plot of Allen deviation curves of the performance of the system of FIG. 9 for various sub-THz frequencies in accordance with certain implementations described herein.

FIG. 11 is a plot of the frequency difference for various runs of varying the temperature of the optical fiber link in accordance with certain implementations described herein.

### DETAILED DESCRIPTION

Extending the concept of RoF to the sub-THz domain can be accomplished by using photonics sources as sub-THz sources through difference frequency generation. In particular, two optical lines separated by THz frequencies incident on fast photo-sensitive elements can generate THz radiation. This process is often called photomixing. Information encoded on a sub-THz frequency can be transferred to one of the optical frequencies, and therefore reconstructed upon photomixing, resulting in the same information on a sub-THz carrier for distribution. Photonic sources of THz can leverage the tools and techniques for frequency stabilization in the optical domain.

Generating terahertz waves with low phase noise levels using photomixing is straightforward when using two optical frequencies with a high degree of phase correlation. A high degree of correlation can be forced externally on two separate laser resonators using phase locked loops (PLLs). Alternatively, the two optical frequencies can originate from the same resonator, thereby passively ensuring correlation, examples of which include, but are not limited to, optical frequency combs (OFCs), dual wavelength (e.g., bi-chromatic) lasers, etc.

When two optical frequencies having a high degree of phase correlation are split and experience different optical paths, differential phase noise is added to each frequency, resulting in a photomixed terahertz signal with larger phase noise than would be achieved had the two frequencies not been split. In some applications, splitting the two optical frequencies or noise can be used to correct for added noise resulting from second order dispersion in the optical fibers.

Certain implementations described herein provide systems, apparatus, and methods for cancelling noise (e.g., maintaining signal integrity and precision) introduced by long optical fiber links used for distribution of microwave, millimeter-wave, sub-terahertz, or terahertz signals carried via two optical frequencies. Certain implementations take as input optical signals with two frequencies that are separated by a frequency corresponding to a microwave, millimeter-wave, sub-terahertz, or terahertz frequency (e.g., in a range of 10 GHz to 10 THz; in a range of 10 GHz to 3 THz). Certain implementations can be used in various applications, including but not limited to: high-speed telecommunication systems (e.g., 5G networks; 6G networks), precision timing and synchronization, remote sensing (e.g., radio astronomy telescope arrays), imaging, and scientific research.

By utilizing an advanced noise cancellation scheme that leverages round-trip light measurements, certain implementations compensate for second-order dispersion and phase drift induced by the optical fiber. Such compensation can facilitate delivery of the THz signal to a remote station with a timing deviation under 100 femtoseconds at all timescale (e.g., effectively canceling Doppler shift effects and preserving the stability of the high-frequency signal).

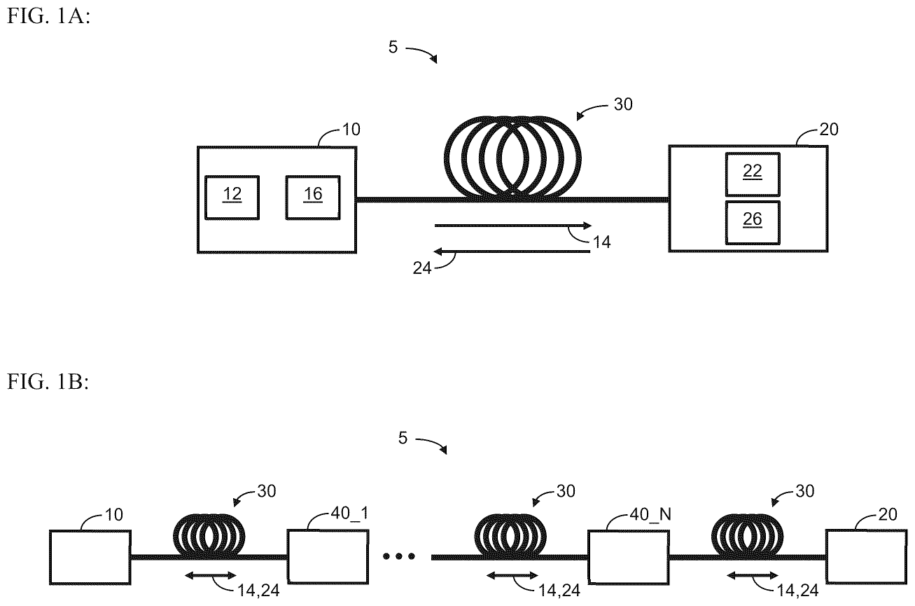

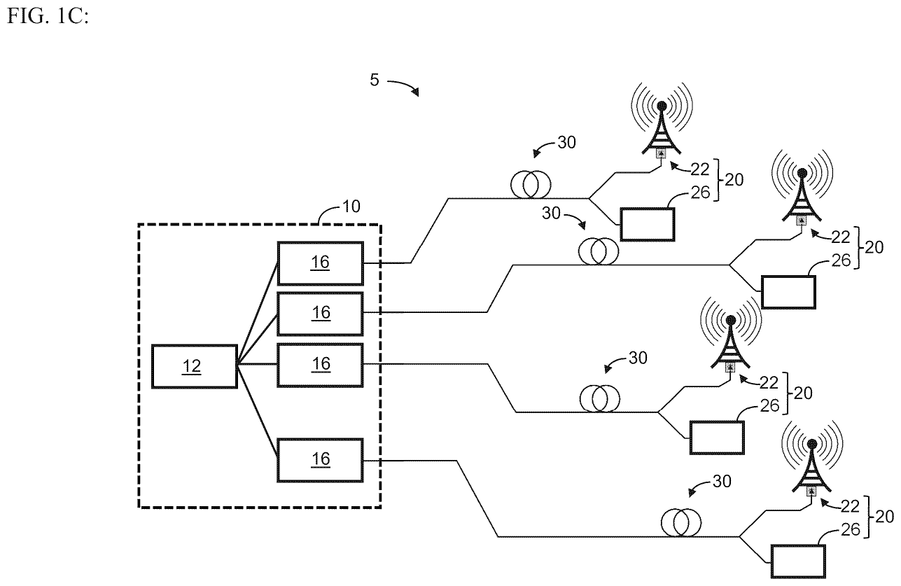

FIGS. 1A-1C schematically illustrate various example systems 5 in accordance with certain implementations described herein. As shown in FIG. 1A, the example system 5 comprises a first station 10 (e.g., a local station), a second station 20 (e.g., a remote station), and at least one optical fiber link 30 in optical communication with the first and second stations 10,20. The first station 10 comprises an optical signal source 12 configured to generate first optical signals 14 comprising two optical frequencies different from one another by a frequency difference in the microwave, millimeter-wave, sub-terahertz, or terahertz range (e.g., dual-wavelength optical signals carrying a terahertz signal) and a fiber noise cancellation module 16 configured to receive the first optical signals 14, adjust at least one of the two optical frequencies, and to transmit the first optical signals 14 to the at least one optical fiber link 30. The at least one optical fiber link 30 can comprise at least one optical fiber (e.g., Corning SMF-28 optical fiber) that is single mode at the two optical frequencies of the first optical signals 14 (e.g., in a telecommunications band around 1550 nanometer wavelength. The at least one optical fiber can have a length greater than 50 kilometers. In certain implementations in which signal loss during propagation of the first optical signals 14 along the at least one optical fiber is substantial, the length of the at least one optical fiber can be less than 160 kilometers. The length of the at least one optical fiber can depend on the sensitivity of the circuitry configured to detect the optical signals and on the amplifiers used to boost the propagating optical signals.

The second station 20 is the intended destination of the first optical signals 14 (e.g., can house scientific equipment associated with the goals of the signal distribution). For example, the second station 20 can comprise circuitry 22 (e.g., an antenna) configured to use a first part of the first optical signals 14 received via the at least one optical fiber link 30. The second station 20 can further comprise a return module 26 for noise cancellation as described herein. For example, the return module 26 can be configured to receive a second part of the first optical signals 14 via the at least one optical fiber link 30, and, in response to the second part of the first optical signals 14, generate second optical signals 24 that are frequency-shifted and reflected versions of the second part of the first optical signals 14, and transmit the second optical signals 24 to the first station 10 via the at least one optical fiber link 30.

The fiber noise cancellation module 16 is configured to controllably adjust one or both of the two optical frequencies of the first optical signals 14 in response to the second optical signals 24. The fiber noise cancellation module 16 can be configured to reduce (e.g., minimize; nullify) a phase difference (e.g., a change of the frequency difference) between the two optical frequencies of the first optical signals 14 at the second station 20 (e.g., caused by propagation of the first optical signals 14 through the at least one optical fiber link 30).

As shown in FIG. 1A, the first station 10 and the second station 20 can be in optical communication with one another via a single optical fiber link 30. As shown in FIG. 1B, the example system 5 can further comprise at least one repeater station 40 (e.g., a plurality of repeater stations 40 comprising repeater stations 40₁, . . . , 40_{N}, where N can be any positive integer) between the first and second stations 10,20 and in series optical communication with one another and with the first and second stations 10,20 via a plurality of optical fiber links 30. In certain implementations, one or more of the at least one repeater station 40 can comprise a fiber noise cancellation module 16. The plurality of repeater stations 40 can be used to boost the optical signals propagating from the first station 10 to the second station 20 while also cancelling noise added to the optical signals by propagating through the plurality of optical fiber links 30 (e.g., each optical fiber link 30 a subdivision of a larger link network). The plurality of repeater stations 40 can also be used as substations of terahertz signal distribution in a linear distribution topography.

FIG. 1C schematically illustrates an example system 5 comprising a first station 10 and a plurality of second stations 20 (e.g., an antenna array of a radio telescope or of a 5G or 6G telecommunications network). The first station 10 comprises an optical signal source 12 (e.g., opto-THz generator) configured to generate the first optical signals 14 (e.g., dual-wavelength optical signals carrying a terahertz signal) and a plurality of fiber noise cancellation modules 16. The example system 5 further comprises a plurality of optical fiber links 30, each optical fiber link 30 in optical communication with a corresponding one of the fiber noise cancellation modules 16 and a corresponding one of the second stations 20. Each second station 20 of the plurality of second stations 20 comprises circuitry 22 (e.g., an antenna) configured to use the first optical signals 14 and a return module 26 configured to generate and transmit second optical signals 24 that are frequency-shifted and reflected versions of the first optical signals 14 to the corresponding fiber noise cancellation module 16 of the first station 10 via the corresponding optical fiber link 30.

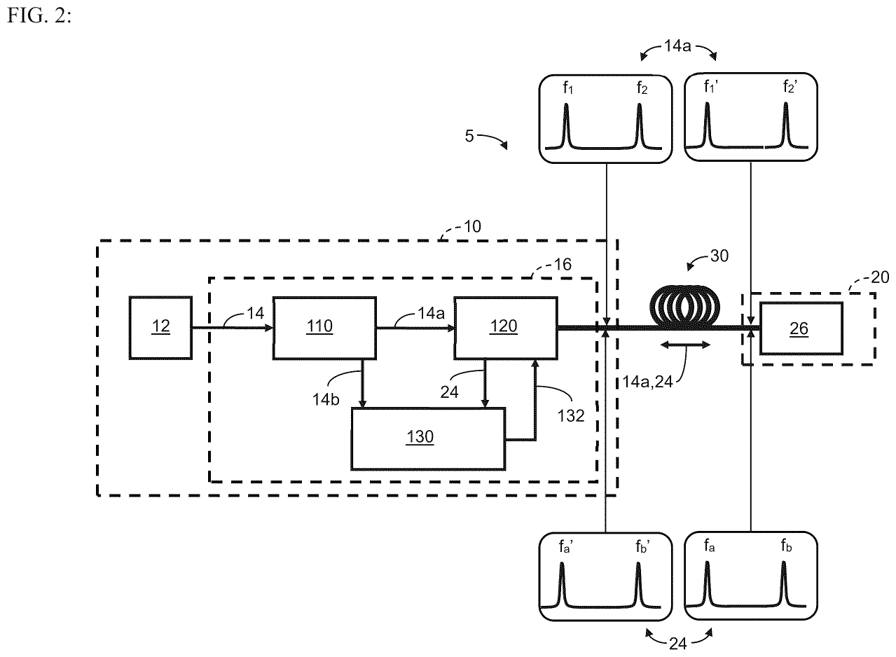

FIG. 2 schematically illustrates an example first station 10 (e.g., local station) in accordance with certain implementations described herein. The first station 10 comprises an optical signal source 12 and a fiber noise cancellation module 16. The optical signal source 12 is configured to generate a first optical signal 14 comprising two optical frequencies f₁, f₂ different from one another by a first frequency difference |f₁−f₂| in the microwave, millimeter-wave, sub-terahertz, or terahertz range (e.g., in a range of 10 GHz to 10 THz). For example, the first optical signal 14 can comprise a dual-wavelength optical signal carrying a terahertz signal. The two optical frequencies can correspond to two wavelengths in a range of 400 nanometers to 1700 nanometers (e.g., in a range of 1300 nanometers to 1600 nanometers, which can have lower losses during propagation through the at least one optical fiber link 30). For example, the two optical frequencies can correspond to wavelengths of 1550 nanometers and 1552.5 nanometers and can have a first frequency difference of 300 GHz. The fiber noise cancellation module 16 comprises a signal preparation module 110, a frequency control module 120, and a detection module 130. As described herein with regard to FIGS. 1A-1C, the first station 10 is in optical communication with at least one second station 20 (e.g., remote station) via at least one optical fiber link 30, and each second station 20 comprises a return module 26 configured to receive at least a portion of the first optical signal 14 via the at least one optical fiber link 30 and, in response, generate and transmit a second optical signal 24 to the first station 10 via the at least one optical fiber link 30.

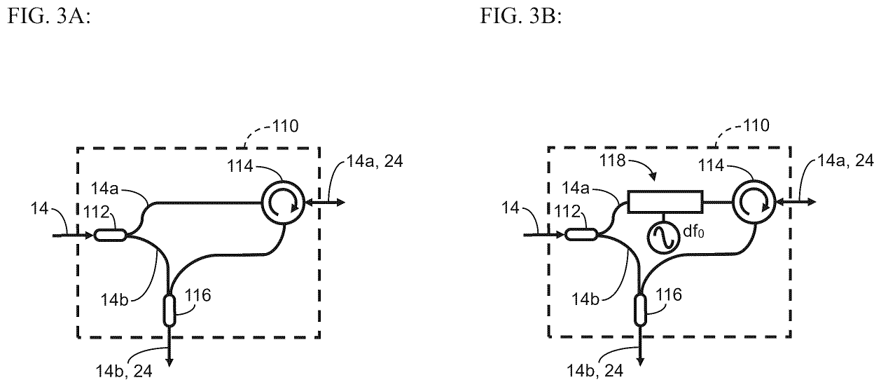

In certain implementations, the signal preparation module 110 comprises an optical circuit configured to receive the first optical signal 14 (e.g., transmitted from the optical signal source 12) and to parse (e.g., split) the first optical signal 14 into a first portion 14a of the first optical signal 14 and a second portion 14b of the first optical signal 14. FIGS. 3A and 3B schematically illustrate two example signal preparation modules 110 in accordance with certain implementations described herein. The signal preparation module 110 can comprise a first coupler 112 (e.g., a 99:1 splitter), a second coupler 114 (e.g., circulator; other coupler or splitter), and a third coupler 116 (e.g., a 50:50 coupler). The first coupler 112 can receive the first optical signal 14 and can transmit the first portion 14a (e.g., 99% of the incident power of the first optical signal 14), via the second coupler 114, to the frequency control module 120. The first coupler 112 can also transmit the second portion 14b (e.g., 1% of the incident power of the first optical signal 14), via the third coupler 116, to the detection module 130. The second coupler 114 can receive the second optical signal 24 (e.g., from the frequency control module 120) and can transmit the second optical signal 24, via the third coupler 116, to the detection module 130. The third coupler 116 can combine the light of the second portion 14b of the first optical signal 14 (e.g., to be used as a “local oscillator” (LO)) with the light of the second optical signal 24, and can send the combined light to the detection module 130.

As schematically illustrated in FIG. 3B, the signal preparation module 110 of certain implementations can further comprise a frequency shifter 118 (e.g., voltage-controlled oscillator (VCO); acousto-optic modulator (AOM)) in optical communication with the first coupler 112 and the second coupler 114, the frequency shifter 118 configured to shift the two first optical frequencies of the first portion 14a that are transmitted to the frequency control module 120. The first portion 14a can pass through the frequency shifter 118, driven at a frequency df₀, and the frequency shifter 118 can equally shift the two optical frequencies f₁, f₂ of the first portion 14a by the frequency df₀, to facilitate heterodyne detection by the detection module 130 (e.g., by differentiating the two optical frequencies of the first portion 14a from the two optical frequencies of the second portion 14b which can be used as the local oscillator (LO)).

While FIGS. 3A and 3B schematically illustrate the second coupler 114 as a component of the signal preparation module 110, in certain other implementations, the second coupler 114 is a component of the frequency control module 120. While FIGS. 3A and 3B schematically illustrate the third coupler 116 as a component of the signal preparation module 110, in certain other implementations, the third coupler 116 is a component of the frequency control module 120 or of the detection module 130.

In certain implementations, the frequency control module 120 comprises an optical circuit configured to receive the first portion 14a of the first optical signal 14 from the signal preparation module 110, to adjust the first portion 14a of the first optical signal 14 in response to at least one control signal 132 by modifying (e.g., shifting) at least one of the two first optical frequencies f₁, f₂ of the first portion 14a, and to transmit the adjusted first portion 14a of the first optical signal 14 to an optical fiber link 30 in optical communication with a device (e.g., the second station 20; a third station 40). For example, the frequency control module 120 can be configured to spectrally and spatially split the first portion 14a of the first optical signal 14, to modify at least one of the two first optical frequencies by applying a controlled frequency shift, and to operate in a double-pass configuration (e.g., such that noise introduced by the frequency control module 120 is cancelled). As described herein, the modified at least one of the first and second optical frequencies f₁, f₂ is shifted to substantially cancel noise added to the first portion 14a by propagation through the at least one optical fiber link 30. The frequency control module 120 can be configured to reduce a fiber-propagation-induced change of the frequency difference between the two first optical frequencies of the first optical signal 14.

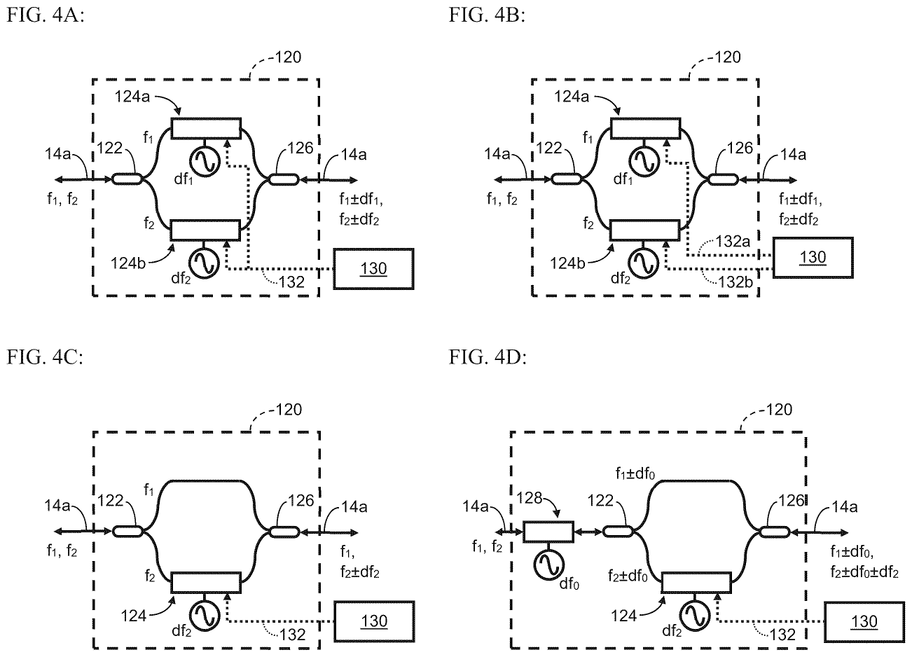

FIGS. 4A-4D schematically illustrate various examples of the frequency control module 120 in accordance with certain implementations described herein. The frequency control module 120 can comprise a first coupler 122 (e.g., a dense wavelength division multiplexer (DWDM)), at least one frequency shifter 124 (e.g., voltage-controlled oscillator (VCO); acousto-optic modulator (AOM)) and a second coupler 126 (e.g., a dense wavelength division multiplexer (DWDM)). The first coupler 122 is configured to receive the first portion 14a of the first optical signal 14 (e.g., from the signal preparation module 110) and to split (e.g., separate) the first portion 14a into a first fraction having the first optical frequency f₁ propagating along a first optical path and a second fraction having the second optical frequency f₂ propagating along a second optical path different from the first optical path. At least one of the first fraction and the second fraction propagates through a corresponding frequency shifter 124 (e.g., AOM) driven at a corresponding frequency and configured to adjust (e.g., modulate) at least one of the first and second frequencies df₁, df₂ (e.g., in a range of 1 MHz to 1 GHz) in response to a control signal 132 received from the detection module 130 (e.g., from a proportional-integral-derivative (PID) controller of the detection module 130). The second coupler 126 is configured to receive the first fraction and the second fraction from the first and second optical paths and to combine the first and second fractions into the first portion 14a of the first optical signal 14 and to transmit the first portion 14a to the at least one optical fiber link 30. The at least one first and second frequency df₁, df₂ added to (e.g., shifting) the corresponding first and second optical frequency f₁, f₂ of the first portion 14a of the first optical signal 14 can be substantially opposite to noise added to (e.g., shifting) the first portion 14a by the first portion 14a propagating through the at least one optical fiber link 30 (e.g., substantially cancelling the noise).

In certain implementations, both of the first and second optical frequencies f₁, f₂ are shifted in response to at least one control signal 132 to substantially cancel the noise. As schematically illustrated by FIG. 4A, the first fraction with the first optical frequency f₁ propagates through a first frequency shifter 124a driven at a first frequency df₁ and the second fraction with the second optical frequency f₂ propagates through a second frequency shifter 124b driven at a second frequency df₂. The first and second frequency shifters 124a,b adjust (e.g., modulate) the first and second frequencies df₁, df₂, respectively, in response to a common control signal 132 received from the detection module 130. As schematically illustrated by FIG. 4B, instead of both the first and second frequency shifters 124a,b adjusting (e.g., modulating) the first and second frequencies df₁, df₂, respectively, in response to the same control signal 132 received from the detection module 130, the first and second frequency shifters 124a,b adjust (e.g., modulate) the first and second frequencies df₁, df₂, respectively, in response to different corresponding control signals 132a,b received from the detection module 130.

In certain implementations, only one of the first and second optical frequencies f₁, f₂ is shifted in response to at least one control signal 132 to substantially cancel the noise. As schematically illustrated by FIG. 4C, the first fraction propagates along the first optical path without a substantive adjustment of the first optical frequency f₁, and is received by the second coupler 126 with the first fraction having the first optical frequency f₁. The second fraction with the second optical frequency f₂ propagates through the frequency shifter 124b driven at a second frequency df₂ which is adjusted (e.g., modulated) in response to a control signal 132 received from the detection module 130. In this way, only one of the two optical frequencies f₁, f₂ experiences a frequency shift. As schematically illustrated by FIG. 4D, the frequency control module 120 comprises a frequency shifter 128 (e.g., voltage-controlled oscillator (VCO); acousto-optic modulator (AOM)) driven at a frequency df₀ and configured to receive the first portion 14a of the first optical signal 14 and to adjust (e.g., modulate) both the first and second optical frequencies f₁, f₂ by a common frequency shift df₀ prior to the first and second fractions being split by the first coupler 122.

In certain implementations, the device (e.g., second station 20) comprises a return module 26 comprising an optical circuit configured to receive at least a portion of the adjusted first portion 14a of the first optical signal 14 from the at least one optical fiber link 30. The return module 26 is further configured to, in response to the received adjusted first portion 14a, generate the second optical signal 24 comprising two second optical frequencies fₐ, f_{b} having the second frequency difference |fₐ−f_{b}|, the two second optical frequencies fₐ, f_{b} of the second optical signal 24 shifted relative to the two first optical frequencies (e.g., f₁′, f₂′, where fₙ′ is the frequency fₙ plus the frequency noise added due to propagation through the at least one optical fiber link 30) of the received adjusted first portion 14a. The return module 26 is further configured to transmit the second optical signal 24 back through the at least one optical fiber link 30. For example, as schematically illustrated by FIG. 2, as a result of propagation of the adjusted first portion 14a of the first optical signal 14 through the at least one optical fiber link 30 (e.g., from the first station 10 to the second station 20), one or both of the two first optical frequencies of the received adjusted first portion 14a can be modified from the values of the two first optical frequencies in the adjusted first portion 14a emitted from the first station 10 (e.g., the two first optical frequencies changed to f₁′ and f₂, f₁ and f₂′, or f₁′ and f₂′) resulting in a changed first frequency difference (e.g., |f₁′−f₂|; |f₁−f₂′|; or |f₁′−f₂′|). The return module 26 is configured to generate the second optical signal 24 in which the two second optical frequencies fₐ, f_{b} are equally shifted relative to the two first optical frequencies (e.g., f₁′, f₂′) of the received adjusted first portion 14a such that a second frequency difference |fₐ−f_{b}| between the two second optical frequencies is equal to the first frequency difference (e.g., |f₁′−f₂′|) between the two first optical frequencies of the adjusted first portion 14a received by the return module 26. In addition, as a result of propagation of the second optical signal 24 through the at least one optical fiber link 30 (e.g., from the second station 20 to the first station 10), one or both of the two second optical frequencies of the second optical signal 24 (e.g., received at the first station 10) can be modified from the values of the two second optical frequencies in the second optical signal 24 prior to the propagation of the second optical signal 24 through the at least one optical fiber link 30 (e.g., the two second optical frequencies changed to fₐ′ and f_{b}, fₐ and f_{b}′, or fₐ′ and f_{b}′) resulting in a changed second frequency difference (e.g., |fₐ′−f_{b}|; |fₐ−f_{b}′|; or |fₐ′−f_{b}′|).

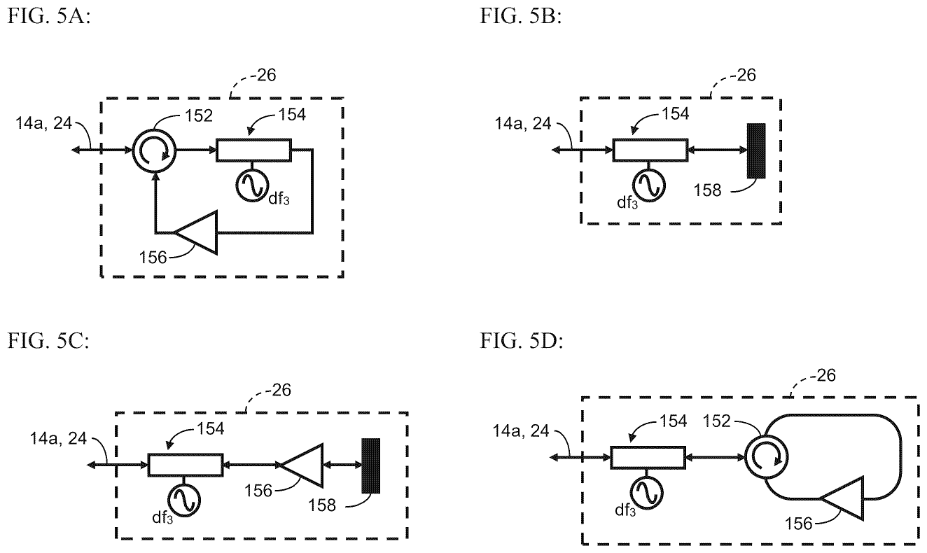

FIGS. 5A-5D schematically illustrate various example return modules 26 in accordance with certain implementations described herein. By generating a second optical signal 24 in which both of the two second optical frequencies fₐ, f_{b} are equally shifted (e.g., a frequency shift larger than the linewidth of the first optical signal 14; larger than the frequency difference between the two first optical frequencies) relative to the two first optical frequencies (e.g., f₁′, f₂′) of the received adjusted first portion 14a, the return module 26 enables the detection module 130 to distinguish between the second optical signal 24 (which carry information indicative of the noise added by propagation through the at least one optical fiber link 30) and optical signals that are backpropagating from the at least one optical fiber link 30 due to backscattering.

As schematically illustrated in FIG. 5A, the return module 26 can comprise a coupler 152 (e.g., circulator), a frequency shifter 154 (e.g., voltage-controlled oscillator (VCO); acousto-optic modulator (AOM)) driven at a frequency df₃ (e.g., in a range of 1 MHz to 1 GHz), and an optical amplifier 156 (e.g., semiconductor optical amplifier (SOA)). The coupler 152 is configured to receive at least a portion of the adjusted first portion 14a of the first optical signal 14 from the at least one optical fiber link 30 (e.g., after the adjusted first portion 14a has propagated through the at least one optical fiber link 30) and to transmit the received adjusted first portion 14a to the frequency shifter 154. The frequency shifter 154 is configured to shift the two first optical frequencies (e.g., f₁′, f₂′) of the received adjusted first portion 14a by the frequency df₃ and to transmit the shifted optical signal (e.g., having two optical frequencies f₁′±df₃, f₂′±df₃) to the optical amplifier 156. The optical amplifier 156 is configured to amplify and transmit the shifted optical signal to the coupler 152. The optical amplification can compensate for loss in the at least one optical fiber link 30 and for splitting of the resultant optical power between the return module 26 and the circuitry 22 (e.g., an antenna) configured to use the received first portion 14a of the first optical signals 14. The coupler 152 is further configured to transmit the shifted and amplified optical signal as the second optical signal 24 back to the at least one optical fiber link 30. While FIG. 5A schematically shows the optical amplifier 156 amplifying the optical signals emitted from the frequency shifter 154, in certain other implementations, the optical amplifier 156 can amplify the optical signals inputted to the frequency shifter 154.

As schematically illustrated in FIG. 5B, the return module 26 can comprise a frequency shifter 154 (e.g., voltage-controlled oscillator (VCO); acousto-optic modulator (AOM)) driven at a frequency df₃ and a retroreflector 158 (e.g., mirror; Faraday rotation mirror). Because the optical signals are transmitted twice through the frequency shifter 154, the two second optical frequencies of the second optical signal 24 emitted from the return module 26 of FIG. 5B are f₁′±2·df₃, f₂′±2·df₃. As schematically illustrated in FIG. 5C, the return module 26 further comprises an optical amplifier 156 (e.g., a bi-directional optical amplifier) between the frequency shifter 154 and the retroreflector 158. As schematically illustrated in FIG. 5D, instead of the retroreflector 158 of FIGS. 5B and 5C, the return module 26 comprises a coupler 152 (e.g., circulator) and an optical amplifier 156 (e.g., a one-directional optical amplifier). Optical signals emitted from the frequency shifter 154 are transmitted to the coupler 152, amplified by the optical amplifier 156 (e.g., in a single pass, as opposed to the double pass of FIG. 5C), and transmitted back to the frequency shifter 154. As in FIG. 5C, the frequency shifter 154 acts on the optical signals twice, such that the two second optical frequencies of the second optical signal 24 emitted from the return module 26 of FIG. 5D are f₁′±2·df₃, f₂′±2·df₃.

In certain implementations, the detection module 130 comprises an optical circuit configured to receive the second portion 14b of the first optical signal 14 and the second optical signal 24, to detect a frequency shift between the second portion 14b of the first optical signal 14 and the second optical signal 24 (e.g., a frequency shift between the two first optical frequencies and the two second optical frequencies), to generate the at least one control signal 132 in response to the frequency shift, and to transmit the at least one control signal 132 to the frequency control module 120. For example, the at least one control signal 132 can be used by the frequency control module 120 to cancel noise added to the resulting sub-THz signal from the at least one optical fiber link 30 by writing the opposite noise onto one of the two optical frequencies of the first optical signal 14. The optical frequencies can then be recombined (e.g., using another frequency splitter/combiner device) and the resultant signal can then be passed to the at least one optical fiber link 30.

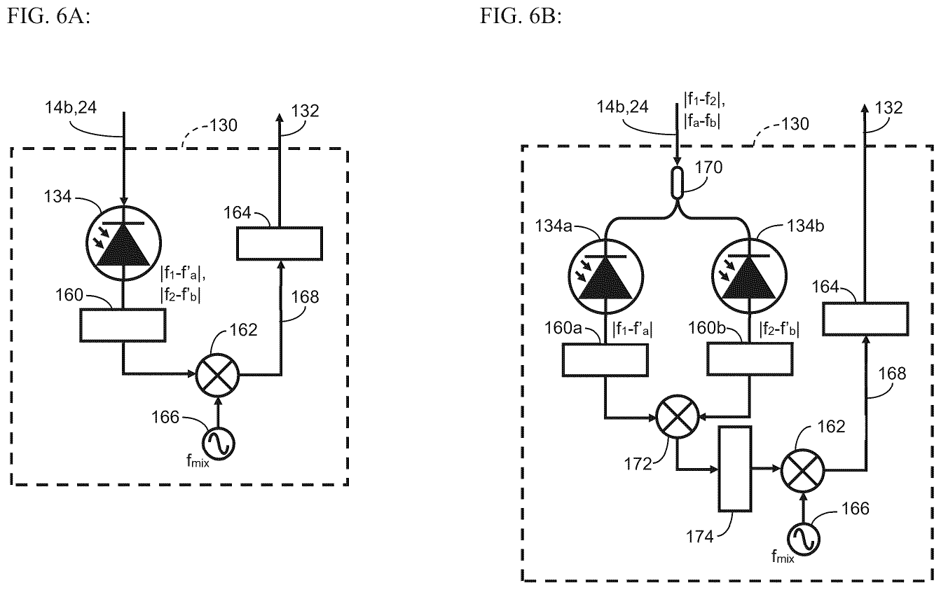

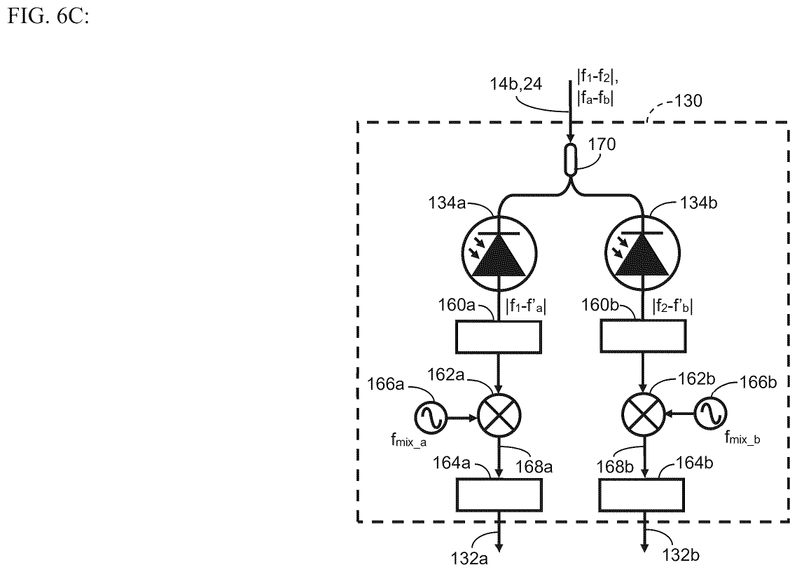

FIGS. 6A-6C schematically illustrate various example detection modules 130 in accordance with certain implementations described herein. As schematically illustrated by FIG. 6A, the detection module 130 comprises at least one photosensitive element 134 (e.g., photodiode) that receives the second portion 14b of the first optical signal 14 (e.g., having the two first optical frequencies f₁, f₂) and the second optical signal 24 (e.g., having the two first optical frequencies fₐ, f_{b}). The at least one photosensitive element 134 acts as a mixer and generates a plurality of electrical signals comprising a first electrical signal indicative of the first frequency difference |f₁−f₂| between the two first optical frequencies f₁, f₂ (e.g., a first beat note signal) and a second electrical signal indicative of the second frequency difference |fₐ-f_{b}| between the two second optical frequencies fₐ, f_{b} (e.g., a second beat note signal). In certain implementations, due to bandwidth limitations on the at least one photosensitive element 134, the detected first and second frequency differences are |f₁−fₐ′| and |f₂−f_{b}′|, because |f₁−f₂| and |fₐ′−f_{b}′| are in a range of 100 GHz to 600 GHz. A second round of mixing can yield |f₁−fₐ′|−|f₂−f_{b}′|, which contains information on the fiber noise. The frequency difference between the first and second beat notes is indicative of the noise imparted by propagation of the first and second optical signals 14, 24 through the at least one optical fiber link 30.

The detection module 130 of FIG. 6A further comprises signal processing circuitry 160 (e.g., one or more splitters, filters, and/or amplifiers), a mixer 162, and a proportional-integral-derivative (PID) controller 164 (e.g., analog or digital servocontroller). The first signal processing circuitry 160 receives and acts upon the first and second beat note signals and provides the resultant signal to the mixer 162. The mixer 162 also receives a third electrical signal from a tunable frequency source 166, the third electrical signal indicative of a reference frequency fₘᵢₓ (e.g., approximately equal to one of the first and second beat notes; having lower absolute noise than does the first and second beat note signals; in a range of 1 MHz to 20 MHz, such as 5.3 MHz), and generates an error signal 168 indicative of the frequency difference between the first and second beat notes. The PID controller 164 receives the error signal 168 and generates the control signal 132 and transmits the control signal 132 to the frequency control module 120.

As schematically illustrated by FIG. 6B, the detection module 130 comprises a frequency splitter 170, first and second photosensitive elements 134a,b (e.g., photodiodes), first and second signal processing circuitry 160a,b, second mixer 172, and third signal processing circuitry 174 (e.g., one or more splitters, filters, and/or amplifiers). The frequency splitter 170 receives the second portion 14b of the first optical signal 14 (e.g., having the two first optical frequencies f₁, f₂) and the second optical signal 24 (e.g., having the two first optical frequencies fₐ′, f_{b}′) and splits the second portion 14b of the first optical signal 14 and the second optical signals 24 from one another to be received, respectively, by the first and second photosensitive elements 134a,b. The first photosensitive element 134a generates the first electrical signal indicative of the first beat note (e.g., |f₁−fₐ′|) and the second photosensitive element 134b generates the second electrical signal indicative of the second beat note (e.g., |f₂−f_{b}′|). By processing the first and second electrical signals separately by the first and second signal processing circuitry 160a,b, certain implementations provide increased signal strength. The second mixer 172 receives the resultant signals from the first and second signal processing circuitry 160a,b and provides the mixed signal to the third signal processing circuitry 174. The third signal processing circuitry 174 is configured to act upon and provide the mixed signal to the mixer 162. The mixer 162, PID controller 164, and tunable frequency source 166 of FIG. 6B operate as described herein with regard to FIG. 6A to generate and transmit the control signal 132 to the frequency control module 120.

While each of the example detection modules 130 of FIGS. 6A and 6B generates a single control signal 132, the example detection module 130 of FIG. 6C generates first and second control signals 132a,b. For example, the first and second control signals 132a,b can be provided to the first and second frequency shifters 124a,b, respectively, of the example frequency control module 120 of FIG. 4B. The frequency splitter 170, first and second photosensitive elements 134a,b, and first and second signal processing circuitry 160a,b of FIG. 6C operate as described herein with regard to FIG. 6B. However, instead of sending the resultant signals to the mixer 172 to be combined and transmitted to the third signal processing circuitry 174, the example detection module 130 of FIG. 6C processes the first and second electrical signals indicative of the first and second beat notes separately. As shown in FIG. 6C, the first beat note signal from the first signal processing circuitry 160a and the second beat note signal from the second signal processing circuitry 160b are, respectively, received by first and second mixers 162a,b, mixed with first and second frequencies f_{mix_a}, f_{mix_b} (e.g., generated by respective first and second tunable frequency sources 166a,b) to generate first and second error signals 168a,b, which are provided to first and second PID controllers 164a,b to generate and transmit the first and second control signals 132a,b to the frequency control module 120. In this way, each beat note signal is processed separately and separate PID controllers are used to feedback each optical frequency of the first optical signals 14.

FIG. 2 schematically illustrates an example first station 10 comprising an optical signal source 12 and a fiber noise cancellation module 16, the first station 10 in optical communication with a second station 20 via an optical fiber link 30 (see, e.g., FIG. 1A) in accordance with certain implementations described herein. However, in certain other implementations, the first station 10 is in optical communication with the second station 20 via at least one third station 40 and at least one optical fiber link 30. The at least one third station 40 can be in series optical communication with the first station 10 and the second station 20 such that the first optical signal 14 emitted from the first station 10 is transmitted to the at least one third station 40 and from the at least one third station 40 to the second station 20. In certain implementations, the at least one third station 40 comprises a plurality of third stations 40 in series optical communication with one another via a plurality of optical fiber links 30 (see, e.g., FIG. 1B). Each third station 40 can be configured to amplify (e.g., boost) the received first optical signals 14 to compensate for losses during propagation through the preceding optical fiber link 30.

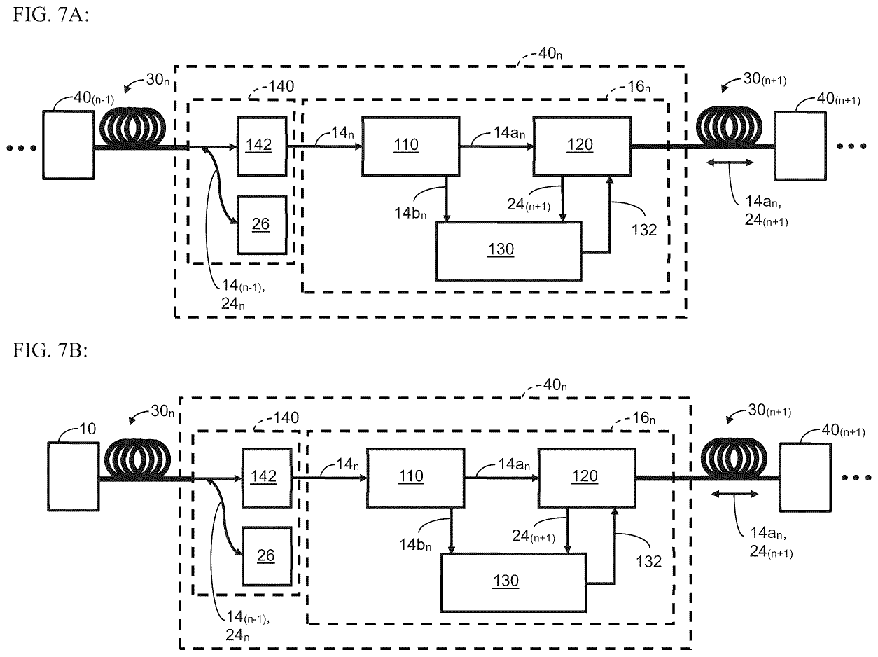

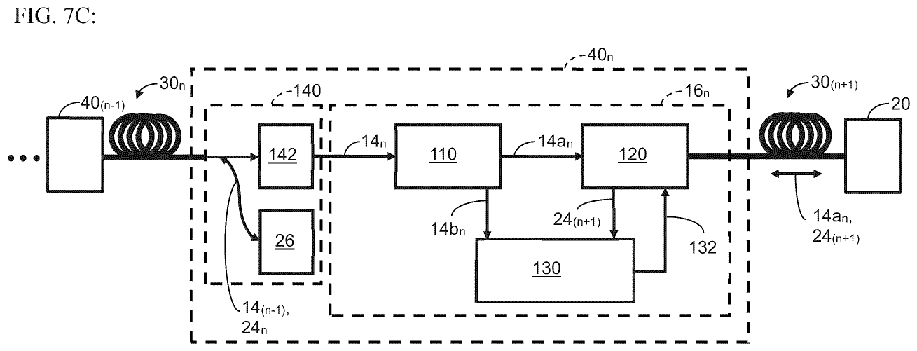

FIGS. 7A-7C schematically illustrate various example third stations 40n (e.g., repeater station) of the at least one third station 40 (e.g., a plurality of third stations 40 as shown in FIG. 1B) in accordance with certain implementations described herein. As shown in FIGS. 7A-7C, the example third station 40ₙ is configured to receive a first optical signal 14₍ₙ₋₁₎ from a preceding third station 40₍ₙ₋₁₎ (see, e.g., FIGS. 7A and 7C) or from the first station 10 (see, e.g., FIG. 7B) via a preceding optical fiber link 30, and to provide a first portion 14aₙ of a first optical signal 14ₙ to a subsequent third station 40₍ₙ₊₁₎ (see, e.g., FIGS. 7A and 7B) or to the second station 20 (see, e.g., FIG. 7C) via a subsequent optical fiber link 30₍ₙ₊₁₎. The example third station 40ₙ is further configured to receive a second optical signal 24₍ₙ₊₁₎ from the subsequent third station 40₍ₙ₊₁₎ (see, e.g., FIGS. 7A and 7B) or the second station 20 (see, e.g., FIG. 7C) via the subsequent optical fiber link 30₍ₙ₊₁₎ and to provide a second optical signal 24ₙ to the preceding third station 40₍ₙ₋₁₎ (see, e.g., FIGS. 7A and 7C) or the first station 10 (see, e.g., FIG. 7B) via the preceding optical fiber link 30ₙ. As used herein, the terms “preceding” and “subsequent” are used to refer to the other optical components (e.g., third stations 40; optical fiber links 30) of the series of alternating third stations 40 and optical fiber links 30 between the first station 10 and the second station 20. In general, a station (e.g., the first station 10; a third station 40) is configured to cancel the noise added by the optical fiber link 30 that connects the station to the “next” station (e.g., the “next” third station 40; the second station 20). For example, as shown in FIG. 2 with no third stations 40, the first station 10 is configured to cancel the noise added by the optical fiber link 30 that connects the first station 10 to the second station 20. For another example, as shown in FIG. 7A, the third station 40₍ₙ₋₁₎ is configured to cancel the noise added by the optical fiber link 30n that connects the third station 40₍ₙ₋₁₎ to the next third station 40ₙ.

As shown in FIGS. 7A-7C, the third station 40ₙ comprises a boost/return module 140 and a fiber noise cancellation module 16ₙ. The boost/return module 140 comprises a boost module 142 configured to receive and amplify (e.g., boost) a first part of the received first optical signal 14ₙ, and to transmit the first part of the received first optical signal 14ₙ to the fiber noise cancellation module 16ₙ. The boost/return module 140 further comprises a return module 26 configured to receive a second part of the received first optical signal 14ₙ and, in response to the second part of the received first optical signal 14ₙ, generate a second optical signal 24ₙ that is a frequency-shifted and reflected version of the second part of the received first optical signal 14ₙ, and transmit the second optical signal 24ₙ to the preceding third station 40₍ₙ₋₁₎ (see, e.g., FIGS. 7A and 7C) or the first station 10 (see, e.g., FIG. 7B) via the preceding optical fiber link 30ₙ. While FIGS. 7A-7C show the boost/return module 140 as comprising separate optical circuits for the boost module 142 and the return module 26, in certain other implementations, the boost/return module 140 comprises a single optical circuit that performs the functions of both the boost module 142 and the return module 26.

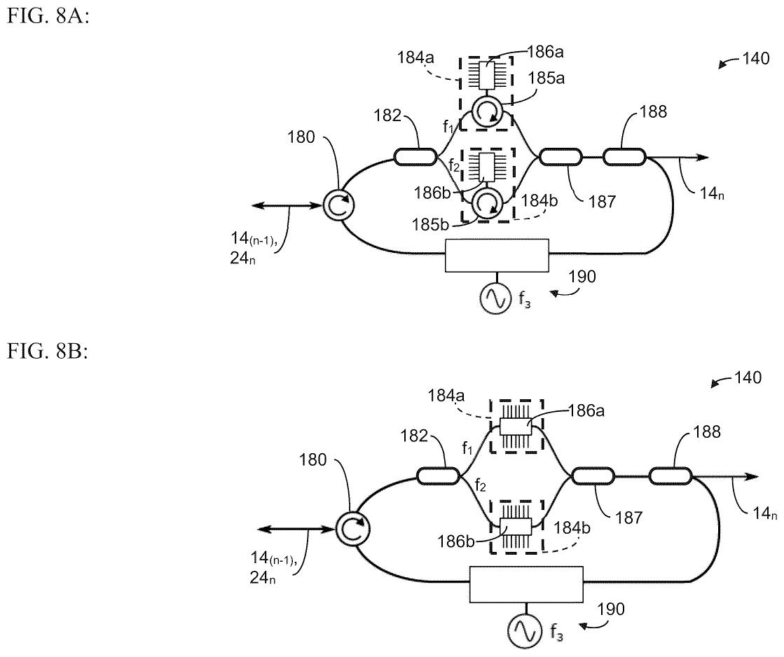

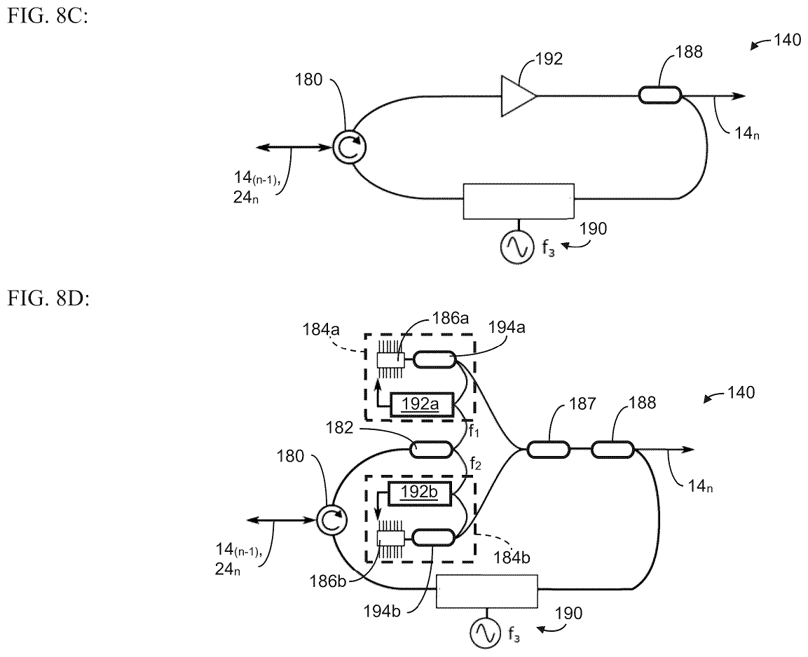

FIGS. 8A-8D schematically illustrate various example boost/return modules 140 in accordance with certain implementations described herein. As shown in FIGS. 8A, 8B, and 8D, the boost/return module 140 of certain implementations comprises a first coupler 180 (e.g., circulator) configured to receive the first optical signal 14₍ₙ₋₁₎ and to transmit the second optical signal 24ₙ. The boost/return module 140 of FIGS. 8A, 8B, and 8D further comprises a second coupler 182 (e.g., frequency-selective splitter; DWDM) configured to split (e.g., separate) the first optical signal 14₍ₙ₋₁₎ into a first fraction having the first optical frequency f₁ propagating along a first optical path through a first amplifier 184a and a second fraction having the second optical frequency f₂ propagating along a second optical path through a second amplifier 184b. The boost/return module 140 of FIGS. 8A, 8B, and 8D further comprises a third coupler 187 (e.g., DWDM) configured to combine the amplified first and second fractions together to form the first optical signal 14ₙ,

In FIG. 8A, the first amplifier 184a comprises a first circulator 185a and a first laser 186a and the second amplifier 184b comprises a second circulator 185b and a second laser 186b, the first laser 186a substantially matching the first optical frequency and the second laser 186b substantially matching the second optical frequency. In FIG. 8B, the first amplifier 184a comprises a first laser 186a and the second amplifier 184b comprises a second laser 186b. In FIG. 8D, the first amplifier 184a further comprises a phase locked loop (PLL) 192a and a first splitter 194a and the second amplifier 184b further comprises a phase locked loop (PLL) 192b and a second splitter 194b. Each PLL 192a,b can replicate the respective portion of the optical signals at higher power within a bandwidth of the PLL 192a,b. The laser 186a has the same frequency as one of the two first optical frequencies and the laser 186b has the same frequency as the other of the two first optical frequencies (e.g., for optical injection locking of each of the lasers 186a,b to the portion of the first optical signal having the same frequency). In FIG. 8B, the optical injection locking is achieved through back facet injection of the lasers 186a,b. In FIG. 8D, phase-lock loops are used instead of optical injection.

Each of the example boost/return modules 140 shown in FIGS. 8A-8D further comprises a fourth coupler 188 and a frequency shifter 190 driven at a frequency f₃. The fourth coupler 188 (e.g., a 99:1 splitter) is configured to transmit a first portion of the first optical signal 14ₙ (e.g., 99% of the incident power of the first optical signal 14ₙ) to the fiber noise cancellation module 16 and a second portion of the first optical signal 14ₙ (e.g., 1% of the incident power of the first optical signal 14ₙ) to the frequency shifter 190 (e.g., voltage-controlled oscillator (VCO); acousto-optic modulator (AOM)) configured to shift the two first optical frequencies of the first optical signal 14ₙ by the frequency f₃ and to transmit the shifted optical signal to the first coupler 180 to be transmitted as the second optical signal 24ₙ.

As shown in FIG. 8C, the boost/return module 140 of certain implementations comprises an optical amplifier 192 configured to amplify the portions of the first optical signal 14ₙ having the two first optical frequencies. As shown in FIG. 8D, the first and second lasers 186a,b are each phase locked to the respective one of the two first optical frequencies to boost the corresponding part of the incoming first optical signal 14₍ₙ₋₁₎.

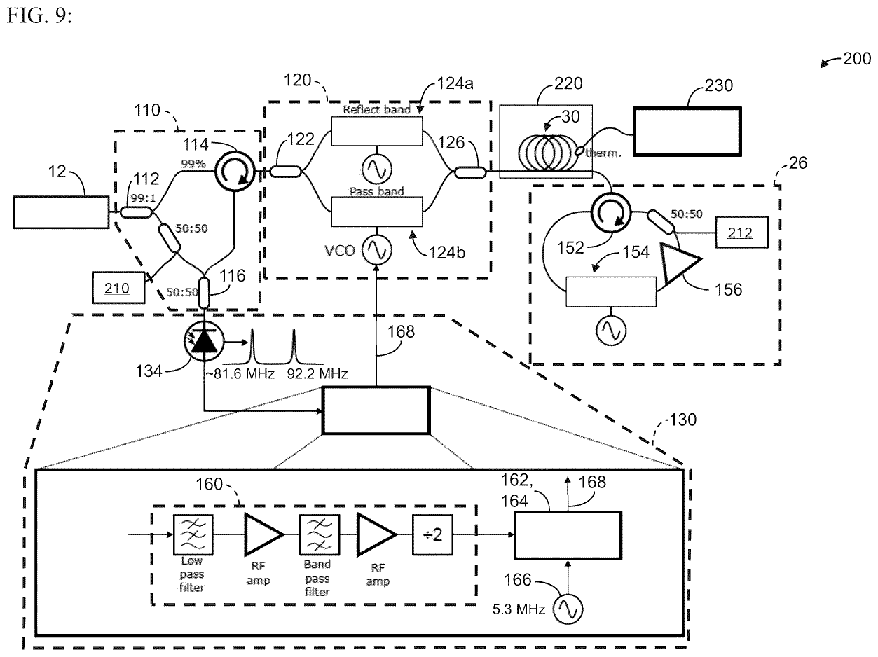

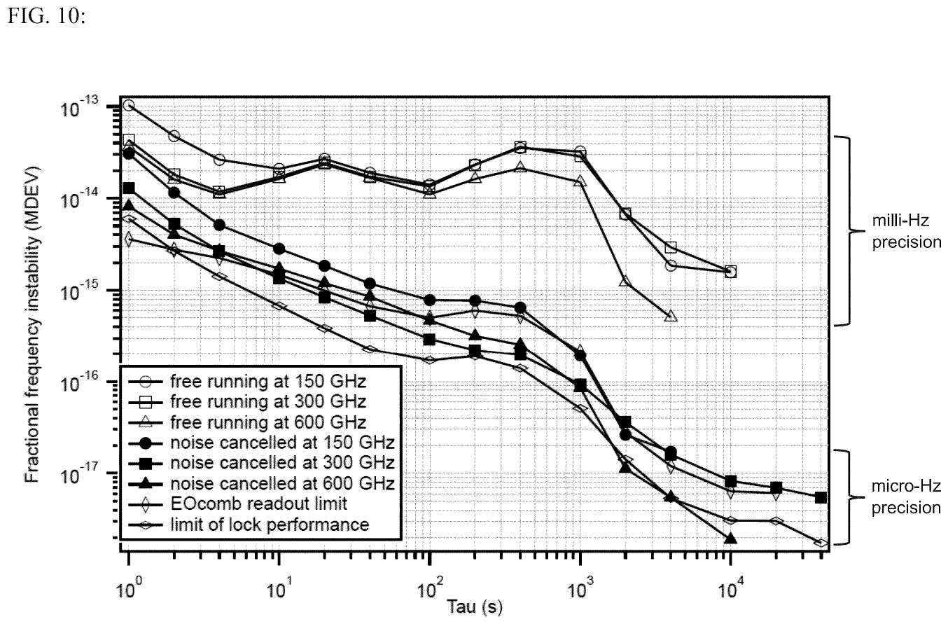

FIG. 9 schematically illustrates an example system 200 in accordance with certain implementations described herein. The system 200 is configured to provide quantitative measurements indicative of a performance of the system 200, as described herein. The system 200 comprises an optical signal source 12 (e.g., THz source), a signal preparation module 110 (see, e.g., FIG. 3A), a frequency control module 120 (see, e.g., FIG. 4A), a detection module 130 (see, e.g., FIG. 6A), and a return module 26 (see, e.g., FIG. 5A). To provide the quantitative measurements, the system 200 further comprises a first electro-optic (EO) comb 210 coupled to the signal preparation module 110 by a 50:50 coupler and a second EO comb 212 coupled to the return module 26 by a 50:50 coupler, the first and second EO combs 210,212 are configured to provide readout of the frequency difference between the two first optical frequencies (e.g., the terahertz signal carried by the first optical signal 14). The optical fiber link 30 of the system 200 comprises an optical fiber having a length of multiple kilometers that is located within a temperature-controlled enclosure 220 (e.g., oven), with a temperature monitor 230 (e.g., thermocouple and readout circuitry) to measure the temperature of the optical fiber link 30.

FIG. 10 is a plot of Allen deviation curves of the performance of the system of FIG. 9 for various sub-THz frequencies in accordance with certain implementations described herein. As seen in FIG. 10, the system 200 with noise cancelling at the tested sub-terahertz frequencies of 150 GHz, 300 GHz, and 600 GHz shows improved fractional frequency instability as compared to the system 200 when free running.

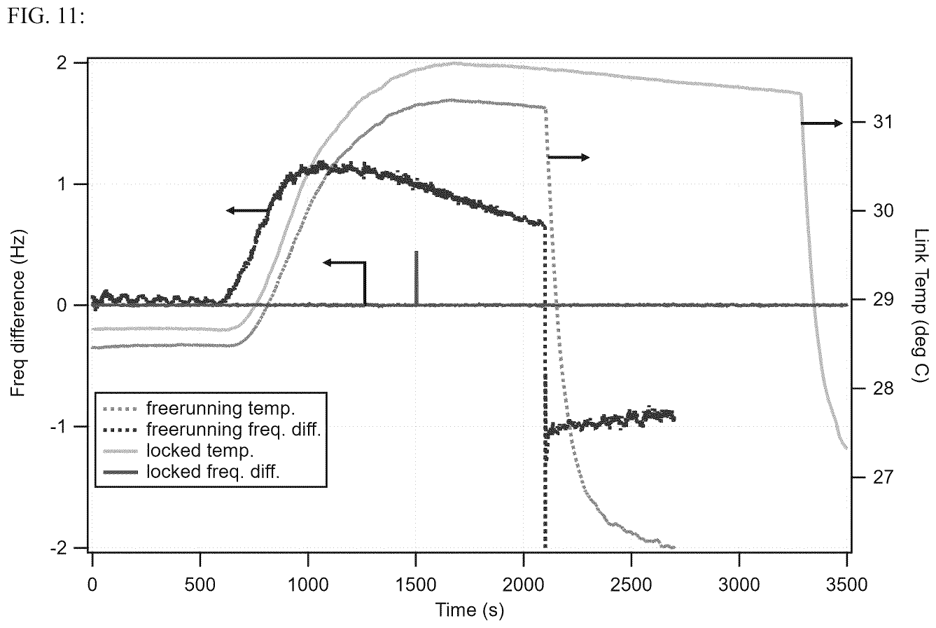

FIG. 11 is a plot of the frequency difference for various runs of varying the temperature of the optical fiber link 30 in accordance with certain implementations described herein. The frequency difference of the optically distributed terahertz signal between the first station 10 (e.g., comprising the fiber noise cancellation module 16) and the second station 20 (e.g., comprising the return module 26) is minimized under locked conditions. These results hold during temperature changes that would otherwise cause large frequency differences between the first and second stations 10, 20.

In certain implementations, evaluation of noise added by the at least one optical fiber link 30, including any noise added by splitting the optical signals into two optical signal portions each having one of the two optical frequencies and propagating the two optical signal portions along non-common paths or noise associated with frequency shifters, is performed after the two optical signal portions have traversed the frequency control module 120 in both directions (e.g., double pass configuration). Evaluation (e.g., via at least one photosensitive element 134) can be performed by optically mixing the two optical signal portions entering the signal preparation module 110 (e.g., from the source 12, boost/return module 140, etc.) with the optical signal portions that have reached and returned from the next station (e.g., next return module 26; boost/return module 140) via photo-sensitive element.

Certain implementations described herein utilize a frequency difference between (i) the optical frequencies of the first optical signals 14 entering the signal preparation module 110 (e.g., which can be considered to be “local copies” or acting as a “local oscillator” for noise signal detection) and (ii) the optical frequencies of the second optical signals 24 which have been returned from the next station. There is a frequency shift in the distributed light that returns from the next station relative to the optical frequencies that leave the station in order to differentiate between light returning from the next station and light that is backscattered in the optical fiber link 30 and therefore does not sample the entire optical fiber link 30. In the frequency control module 120, the frequency shifting can be realized on one or both of the two optical frequencies separately, so that a controllable change in the frequency difference of the two optical frequencies can be realized. The values of the frequency shifts do not result in optical signals that overlap with each other or with spurious signals.

As described herein, a number of frequency-shifting devices can be used to detect an unambiguous signal associated with noise added by an optical fiber link 30 (e.g., the noise to be cancelled). While certain implementations are described herein as having particular configurations of these frequency-shifting devices, certain other implementations have other configurations (e.g., the use of a frequency-shifting device in general is context specific). While certain implementations are described herein as having particular configurations of optical amplification elements, certain other implementations have other configurations (e.g., the use of an optical amplification element in general is context specific). While certain implementations are described herein without referring to polarization control devices (e.g., the use of polarization control devices is context sensitive), certain other implementations utilize polarization control devices (e.g., to optimize signal).

Example, non-limiting experimental data are included herein to illustrate results achievable by various implementations of the systems and methods described herein. All ranges of data and all values within such ranges of data that are shown in the figures or described in the specification are expressly included in this disclosure. The example experiments, experimental data, tables, graphs, plots, figures, and processing and/or operating parameters (e.g., values and/or ranges) described herein are intended to be illustrative of operating conditions of the disclosed systems and methods and are not intended to limit the scope of the operating conditions for various implementations of the methods and systems disclosed herein. Additionally, the experiments, experimental data, calculated data, tables, graphs, plots, figures, and other data disclosed herein demonstrate various regimes in which implementations of the disclosed systems and methods may operate effectively to produce one or more desired results. Such operating regimes and desired results are not limited solely to specific values of operating parameters, conditions, or results shown, for example, in a table, graph, plot, or figure, but also include suitable ranges including or spanning these specific values. Accordingly, the values disclosed herein include the range of values between any of the values listed or shown in the tables, graphs, plots, figures, etc. Additionally, the values disclosed herein include the range of values above or below any of the values listed or shown in the tables, graphs, plots, figures, etc. as might be demonstrated by other values listed or shown in the tables, graphs, plots, figures, etc. Also, although the data disclosed herein may establish one or more effective operating ranges and/or one or more desired results for certain implementations, it is to be understood that not every implementation need be operable in each such operating range or need produce each such desired result. Further, other implementations of the disclosed systems and methods may operate in other operating regimes and/or produce other results than shown and described with reference to the example experiments, experimental data, tables, graphs, plots, figures, and other data herein.

The invention has been described in several non-limiting implementations. It is to be understood that the implementations are not mutually exclusive, and elements described in connection with one implementation may be combined with, rearranged, or eliminated from, other implementations in suitable ways to accomplish desired design objectives. No single feature or group of features is necessary or required for each implementation. Various modifications and applications may occur to those skilled in the art without departing from the true spirit and scope of the invention. Thus, for example, in any method or process disclosed herein, the acts or operations making up the method/process may be performed in any suitable sequence and are not necessarily limited to any particular disclosed sequence. Features or elements from various implementations and examples discussed above may be combined with one another to produce alternative configurations compatible with implementations disclosed herein.

For purposes of summarizing the present invention, certain aspects, advantages and novel features of the present invention are described herein. It is to be understood, however, that not necessarily all such advantages may be achieved in accordance with any particular implementation. Thus, the present invention may be embodied or carried out in a manner that achieves one or more advantages without necessarily achieving other advantages as may be taught or suggested herein.

As used herein any reference to “one implementation” or “some implementations” or “an implementation” or “certain implementations” means that a particular element, feature, structure, or characteristic described in connection with the implementation is included in at least one implementation. The appearances of the phrase “in one implementation” or “in certain implementations” in various places in the specification are not necessarily all referring to the same implementation. Conditional language used herein, such as, among others, “can,” “could,” “might,” “may,” “e.g.,” and the like, unless specifically stated otherwise, or otherwise understood within the context as used, is generally intended to convey that certain implementation include, while other implementations do not include, certain features, elements and/or steps. In addition, the articles “a” or “an” or “the” as used in this application and the appended claims are to be construed to mean “one or more” or “at least one” unless specified otherwise.

As used herein, the terms “comprises,” “comprising,” “includes,” “including,” “has,” “having” or any other variation thereof, are open-ended terms and intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), or both A and B are true (or present). As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain implementations require at least one of X, at least one of Y, and at least one of Z to each be present.

Language of degree, as used herein, such as the terms “approximately,” “about,” “generally,” and “substantially,” represent a value, amount, or characteristic close to the stated value, amount, or characteristic that still performs a desired function or achieves a desired result. For example, the terms “approximately,” “about,” “generally,” and “substantially” may refer to an amount that is within ±10% of, within ±5% of, within ±2% of, within ±1% of, or within ±0.1% of the stated amount. The ranges disclosed herein also encompass any and all overlap, sub-ranges, and combinations thereof. Language such as “up to,” “at least,” “greater than,” less than,” “between,” and the like includes the number recited. As used herein, the meaning of “a,” “an,” and “said” includes plural reference unless the context clearly dictates otherwise. While the structures and/or methods are discussed herein in terms of elements labeled by ordinal adjectives (e.g., first, second, etc.), the ordinal adjectives are used merely as labels to distinguish one element from another, and the ordinal adjectives are not used to denote an order of these elements or of their use.

Thus, while only certain implementations have been specifically described herein, it will be apparent that numerous modifications may be made thereto without departing from the spirit and scope of the invention. Further, acronyms are used merely to enhance the readability of the specification and claims. It should be noted that these acronyms are not intended to lessen the generality of the terms used and they should not be construed to restrict the scope of the claims to the implementations described therein.

What is claimed is:

1. An apparatus comprising:
a signal preparation module configured to:
receive a first optical signal comprising two first optical frequencies having a first frequency difference in a range of 10 GHz to 10 THz; and
parse the first optical signal into a first portion of the first optical signal and a second portion of the first optical signal;
a frequency control module configured to:
receive the first portion of the first optical signal from the signal preparation module;
adjust the first portion of the first optical signal in response to at least one control signal by modifying at least one of the two first optical frequencies;
transmit the adjusted first portion of the first optical signal to at least one optical fiber link in optical communication with a device configured to:
receive at least a portion of the adjusted first portion of the first optical signal from the at least one optical fiber link;
in response to the received adjusted first portion, generate a second optical signal comprising two second optical frequencies having a second frequency difference, the two second optical frequencies shifted equally relative to the two first optical frequencies of the received adjusted first portion; and
transmit the second optical signal back through the at least one optical fiber link; and
receive the second optical signal from the at least one optical fiber link; and
a detection module configured to:
receive the second portion of the first optical signal and the second optical signal;
detect a frequency shift between the second portion of the first optical signal and the second optical signal;
generate the at least one control signal in response to the frequency shift; and
transmit the at least one control signal to the frequency control module.

2. The apparatus of claim 1, further comprising an optical signal source configured to generate the first optical signals and to transmit the first optical signals to the signal preparation module.

3. The apparatus of claim 1, further comprising at least one optical component configured to amplify the first optical signals.

4. The apparatus of claim 1, wherein the signal preparation module comprises an optical circuit comprising a first coupler, a second coupler, and a third coupler, the first coupler configured to receive the first optical signal, to transmit the first portion to the second coupler, and to transmit the second portion to the third coupler, the second coupler configured to transmit the first portion to the frequency control module, to receive the second optical signal from the frequency control module, and to transmit the second optical signal to the third coupler, the third coupler configured to transmit the first portion and the second optical signal to the detection module.

5. The apparatus of claim 4, wherein the signal preparation module further comprises a frequency shifter in optical communication with the first coupler and the second coupler, the frequency shifter configured to equally shift the two first optical frequencies of the first portion that are transmitted to the frequency control module.

6. The apparatus of claim 1, wherein the frequency control module is configured to:
spectrally and spatially split the first portion of the first optical signal;
modify the at least one of the two first optical frequencies by applying a controlled frequency shift to the at least one of the two first optical frequencies; and
operate in a double-pass configuration such that noise introduced by the frequency control module is canceled.

7. The apparatus of claim 1, wherein the frequency control module comprises a first coupler configured to receive the first portion of the first optical signal and to split the first portion into a first fraction having the first optical frequency propagating along a first optical path and a second fraction having the second optical frequency propagating along a second optical path different from the first optical path, at least one frequency shifter configured to receive at least one of the first and second fractions, to adjust at least one frequency shift in response to at least one control signal, and to shift at least one of the first and second optical frequencies by the at least one frequency shift, and a second coupler configured to receive and combine the first fraction and the second fraction into the first portion of the first optical signal and to transmit the first portion to the at least one optical fiber link.

8. The apparatus of claim 1, wherein the second optical signal is a frequency-shifted and reflected version of the second portion of the first optical signal.

9. The apparatus of claim 1, wherein the detection module comprises:
at least one photosensitive element configured to receive the second portion of the first optical signal and the second optical signal and to generate a plurality of electrical signals comprising a first electrical signal indicative of a first frequency difference between the two first optical frequencies and a second electrical signal indicative of a second frequency difference between the two second optical frequencies;
signal processing circuitry configured to receive and act upon the first and second electrical signals and to generate at least one resultant signal;
at least one mixer, each mixer configured to receive a corresponding resultant signal and a third electrical signal indicative of a corresponding reference frequency and to generate a corresponding error signal; and
at least one proportional-integral-derivative (PID) controller, each PID controller configured to receive the corresponding error signal and to generate and transmit a corresponding control signal to the frequency control module.

10. The apparatus of claim 9, wherein the detection module further comprises a frequency splitter configured to split the second portion of the first optical signal and the second optical signal from one another, the at least one photosensitive element comprises a first photosensitive element configured to generate the first electrical signal in response to the second portion of the first optical signal and a second photosensitive element configured to generate the second electrical signal in response to the second optical signal, and the signal processing circuitry comprises a first signal processing circuitry configured to generate a first resultant signal in response to the first electrical signal and a second signal processing circuitry configured to generate a second resultant signal in response to the second electrical signal.

11. The apparatus of claim 10, wherein the at least one PID controller comprises a first PID controller and a second PID controller, the first PID controller configured to generate and transmit a first control signal to the frequency control module, the second PID controller configured to generate and transmit a second control signal to the frequency control module, the first control signal indicative of a first frequency shift to be applied by the frequency control module to the one of the two first optical frequencies and the second control signal indicative of a second frequency shift to be applied by the frequency control module to another of the two first optical frequencies.

12. The apparatus of claim 1, wherein the detection module comprises:
a first photosensitive element configured to receive the second portion of the first optical signal and to generate a first electrical signal indicative of a first frequency difference between the two first optical frequencies;
a second photosensitive element configured to receive the second optical signal and to generate a second electrical signal indicative of a second frequency difference between the two second optical frequencies;
first and second signal processing circuitry configured to receive and act upon, respectively, the first and second electrical signals and to generate, respectively first and second resultant signals;
a mixer configured to receive the first and second resultant signals to generate a mixed signal;
a third signal processing circuitry configured to receive and act upon the mixed signal;
a second mixer configured to receive the mixed signal and an electrical signal indicative of a reference frequency and to generate an error signal; and
a proportional-integral-derivative (PID) controller configured to receive the error signal and to generate and transmit a control signal to the frequency control module.

13. The apparatus of claim 12, wherein the control signal is indicative of a frequency shift to be applied by the frequency control module to at least one of the two first optical frequencies.

14. The apparatus of claim 1, wherein the detection module is configured to measure a frequency shift of the two second optical frequencies relative to the two first optical frequencies and the frequency control module is configured to respond to the at least one control signal by cancelling noise resulting from propagation through the at least one optical fiber link.

15. The apparatus of claim 14, wherein the frequency control module is configured to reduce a fiber-propagation-induced change of the frequency difference between the two first optical frequencies of the first optical signal.

16. A system comprising:
a local station comprising a source of optical signals, each optical signal comprising two optical frequencies having a first frequency difference in a range of 10 GHz to 10 THz; and
at least one repeater station and at least one optical fiber configured to transmit the optical signals from the local station to at least one remote station, wherein the local station and/or at least one of the at least one repeater station comprises:
a first optical circuit configured to transmit a first power fraction of the optical signals along a first optical path and to transmit a second power fraction of the optical signals along a second optical path different from the first optical path;
a second optical circuit configured to generate a modified first power fraction by modifying the two optical frequencies of the first power fraction in response to control signals; and
a third optical circuit configured to detect shifts of the two optical frequencies that are induced by propagation of the optical signals through the at least one optical fiber and to generate the control signals in response to the detected shifts.

17. The system of claim 16, further comprising the at least one remote station, and the at least one remote station is configured to amplify and frequency-shift a portion of the optical signals received from the at least one repeater station and the at least one optical fiber and to route the amplified and frequency-shifted portion back to the at least one optical fiber and the at least one repeater station.

18. The system of claim 16, wherein the at least one of the at least one repeater station comprises a fourth optical circuit configured to amplify portions of the optical signals received by the fourth optical circuit.

19. The system of claim 18, wherein the fourth optical circuit comprises at least one optical amplifier configured to amplify portions of the optical signals having the two optical frequencies.

20. The system of claim 18, wherein the fourth optical circuit is configured to separately amplify portions of the optical signals having the two optical frequencies, the fourth optical circuit comprising:
at least one frequency-selective splitter configured to split the optical signals into first portions having a first optical frequency of the two optical frequencies and second portions having a second optical frequency of the two optical frequencies;
a first laser substantially matching the first optical frequency and configured to amplify the first portions;
a second laser substantially matching the second optical frequency and configured to amplify the second portions; and
an optical coupler configured to combine the amplified first portions and the amplified second portions.

21. The system of claim 20, wherein at least one of the first and second lasers amplifies through optical injection locking.

22. The system of claim 20, wherein at least one of the first and second lasers is phase-locked using a phase-locked loop to replicate the optical signals at higher power within a bandwidth of the phase-locked loop.

23. The system of claim 20, wherein the at least one optical fiber is configured to introduce phase and frequency noise onto the optical signals and the at least one repeater station and/or the at least one remote station is configured to detect and correct the phase and frequency noise.

24. A method for phase and frequency noise cancellation in microwave, millimeter-wave, sub-terahertz, or terahertz signals transmitted over at least one optical fiber link between a first station and at least one second station, the method comprising:
generating optical signals comprising two separate optical frequencies having a frequency difference in a range of 10 GHz to 10 THz;
transmitting the optical signals along an optical path through the at least one optical fiber link;
detecting phase and frequency fluctuations at the at least one second station; and
applying error correction signals to the optical signals at one or more locations along the optical path, the error correction signals comprising frequency shifts derived from the detected phase and frequency fluctuations to mitigate noise in real-time.

25. The method of claim 24, wherein the noise comprises phase and frequency noise applied by propagation of the optical signals through the at least one optical fiber link.

26. The method of claim 24, wherein the frequency shifts are controlled by an electrical signal generated by a servocontroller in response to detected noise.

27. The method of claim 24, wherein the at least one second station is configured to frequency-shift the optical signals received from the at least one optical fiber link and to route the frequency-shifted optical signals back through the at least one optical fiber link in a counterpropagating configuration.

28. The method of claim 24, further comprising generating the error correction signals by detecting the phase and frequency fluctuations and the error correction signals comprise an electrical carrier frequency indicative of the phase and frequency fluctuations.
